(19) United States
(12) Patent Application Publication
(10) Pub. No.: US 2011/0235258 A1
(43) Pub. Date: Sep. 29, 2011

(54) NOTEBOOK COMPUTER AND MOTHERBOARD MODULE THEREOF

(75) Inventors: KUANG-LIANG CHEN, Taoyuan County (TW); CHING-TSAI CHANG, Taipei County (TW); YUN-PING LIU, Keelung City (TW); WEN-BIN TSAY, Taipei City (TW)

(73) Assignee: ELITEGROUP COMPUTER SYSTEMS CO., LTD., Taipei City (TW)

(21) Appl. No.: 12/729,255

(22) Filed: Mar. 23, 2010

(51) Int. Cl. G06F 1/16; G06F 1/20

(52) U.S. Cl. 361/679.26; 361/679.55; 361/679.54

(57) ABSTRACT

The present invention discloses a notebook computer and a motherboard module thereof. The notebook computer comprises a base module, a motherboard module, and a screen module. The base module comprises a base and a base casing. Besides, the screen module is pivotally connected to the base casing and is electrically connected to the base. Furthermore, the motherboard module comprises a motherboard and a motherboard cover, and the motherboard cover is integrated with the motherboard and disposed to cover one side of the motherboard. When the motherboard electrically connects to the base, the base casing is seamlessly connecting to the motherboard cover so as to establish an integral whole appearance. As a result, the difficulty of the removal can be surmounted, and the plug-in and unplugging frequency of the connectors of the notebook computer during the removal process can be lower.

### FIELD

The present invention relates to a field of notebook computer. More specifically, the present invention relates to a notebook computer and a motherboard module thereof.

### BACKGROUND

In the conventional design of the notebook computer, the circuit board and the motherboard both are fixed on the upper casing and the lower casing of the notebook computer by screws. Also, most of the circuit boards are connected by the connecting wire. However, the conventional design has following drawbacks.

First of all, because the motherboard has been locked up on the upper casing or the lower casing, the user must take the upper casing and the lower casing apart to remove the motherboard when he/she wants to maintain or upgrade the notebook computer. However, the connection between the upper casing and the lower casing of the notebook computer are established with high intensity to maintain the stability thereof. Therefore, not only users are unable to take apart the upper and lower casing by themselves, even in the case that the removal of the motherboard is operated by professional mechanics, the stability of the notebook computer still be affected in the assembling process. Also, the process of removal is time-consuming and thus the maintenance cost of the computer companies is increased. Besides, many connectors must be plugged in and unplugged during the maintenance, which would easily damage the connectors.

### SUMMARY

Due to the long felt need to find out the solution of the abovementioned problems, an aspect of the present invention is providing a notebook computer and a motherboard module thereof in order to simplify the process that removes the motherboard from the notebook computer.

Another aspect of the present invention is providing a notebook computer and a motherboard module thereof in order to lower the plug-in and unplugging frequency of the connectors of the notebook computer during the removal of the motherboard.

According to another aspect of the present invention, a notebook computer comprises a base module, a motherboard module, at least one connector, and a screen module. The base module comprises a base and a base casing, and the base is disposed in the base casing. Besides, the screen module is pivotally connected to the base casing and is electrically connected to the base. Furthermore, the motherboard module comprises a motherboard and a motherboard cover, the motherboard electrically connects to the base, and the motherboard cover is integrated with the motherboard and is disposed to cover one side of the motherboard. When the motherboard electrically connects to the base, the base casing is seamlessly connecting to the motherboard cover to establish an integral whole appearance.

In the aforementioned embodiment, the base may further comprise a guide pin to position the motherboard. Also, the motherboard may further comprise an input/output interface port to connect with peripheral devices of the notebook computer. Moreover, the input/output interface port may be integrated with the motherboard cover.

According to another aspect of the present invention, a motherboard module, for assembling with a base module of a notebook computer, comprises a motherboard and a motherboard module cover. The motherboard comprises at least one of a processor, a memory, a chip set, and an input/output interface port. The processor processes data and programs, and the memory stores data and programs. Further, the chip set communicates with the processor and peripheral devices of the notebook computer, and the input/output interface port connects with peripheral devices of the notebook computer. Also, the motherboard cover is integrated with the motherboard and disposed to cover one side of the motherboard. Moreover, the input/output interface port is integrated with the motherboard cover.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a schematic view of a notebook computer and a motherboard module thereof in accordance with one embodiment of the present invention;

FIG. 2 illustrates a schematic view of a motherboard module in accordance with one embodiment of the present invention;

FIG. 3 illustrates a schematic view of a motherboard module in accordance with one embodiment of the present invention;

FIG. 4 illustrates a schematic view of a motherboard module in accordance with one embodiment of the present invention;

### DETAILED DESCRIPTION

Exemplary embodiments of the present invention are described herein in the context of a notebook computer and a motherboard module thereof.

Those of ordinary skilled in the art will realize that the following detailed description of the exemplary embodiment is illustrative only and is not intended to be in any way limiting. Other embodiments will readily suggest themselves to such skilled persons having the benefit of this disclosure. Reference will now be made in detail to implementations of the exemplary embodiment as illustrated in the accompanying drawings.

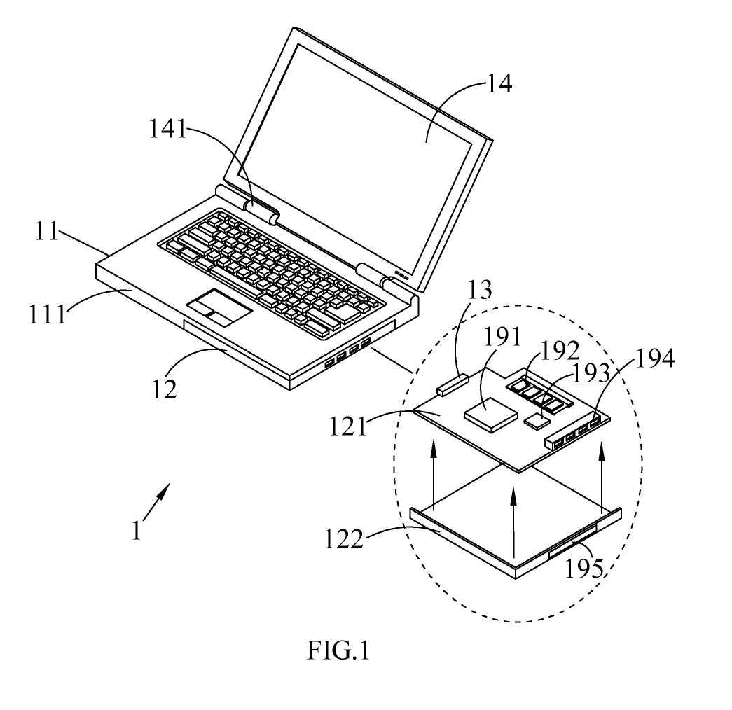

Please refer to FIG. 1, which is a schematic view of a notebook computer and a motherboard module thereof in accordance with one embodiment of the present invention. The notebook computer 1 in FIG. 1 comprises a base module 11, a motherboard module 12, at least one connector 13, and a screen module 14.

The motherboard module 12 comprises a motherboard 121 and a motherboard cover 122, the motherboard 121 is electrically connected to the base (not shown in FIG. 1) of the base module 11, and the motherboard cover 122 is integrated with the motherboard 121 and disposed to cover one side of the motherboard 121. The motherboard 121 comprises at least one of a processor 191, a memory 192, and a chip set 193. The processor 191 processes data and programs, and the memory 192 stores data and programs. Further, the chip set 193 communicates with the processor 191 and peripheral devices of the notebook computer 1.

Besides, the motherboard 121 may further comprise an input/output interface port 194 for connecting with peripheral devices of the notebook computer 1. Further, the input/output interface port 194 is integrated with the motherboard cover 122. For example, a hole 195 is located on one side of the motherboard cover 122, and the input/output interface port 194 is embedded in the hole 195 while the motherboard cover 122 is integrated with the motherboard 121.

The base module 11 comprises a base (not shown in FIG. 1) and a base casing 111, and the base is disposed in the base casing 111. Besides, the screen module 14 is pivotally connected to the base casing 111 by a hinge 141 so as to rotate around the base casing 111. When the motherboard 121 electrically connects to the base, the base casing 111 is seamlessly connecting to the motherboard cover so as to establish an integral whole appearance. Moreover, when the motherboard 121 connects the base, the motherboard module 12 is integrated with base module 11 by screwing or engaging.

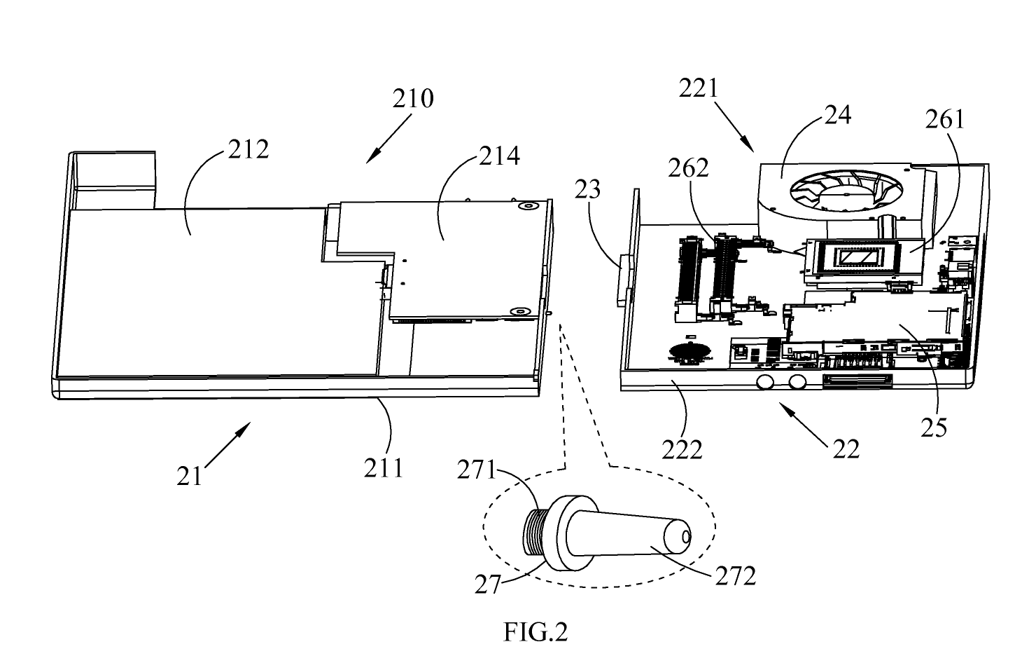

Please refer to FIG. 2, which illustrates a schematic view of a motherboard module in accordance with one embodiment of the present invention. In FIG. 2, the appearance of the base module 21 and the module 22 is corresponding to the battery of the notebook computer (not shown in FIG. 2). The base module 21 comprises a base and a base casing 211, and the base comprises an extension module 212 and an extension circuit board 214, wherein the extension module 212 electrically connects to the extension circuit board 214.

The motherboard module 22 comprises a motherboard 221 and a motherboard 222. Further, a processor 261, a memory socket 262 to install memories, a card reader 25, and a heat sink module 24 may be disposed on the motherboard 221. That is, the designer of the notebook computer may install some general replaced units or devices in the motherboard module 22. Hence, users may upgrade or maintain the notebook computer much easier. For instance, after upgrading to a more powerful processor 261, the user might want to replace a better heat sink module 24 as well, and these replacements can be more easily achieved by the motherboard module 22 in the present invention.

Furthermore, the base 210 may further comprise an extension module signal bus electrically connected to the extension module 212 and base 210, and signals transmitted via the extension module signal bus are sent to the motherboard 221 through a connector 23. The extension module 212 may be a hard disk or an optical disk, and the extension module signal bus may comprise a hard disk signal bus or an optical signal bus accordingly.

Moreover, the signal bus of the screen module of the notebook computer may connect to the base 210 and then transmit the screen signals to the motherboard 221 through the connector 23. Because the connecting strength of the cable or bus is lower than that of the connector 23, the number of the cable or bus that connects to the motherboard 221 may be reduced by the aforementioned arrangement. Further, during the removal of the motherboard module 22, the plug-in and unplugging frequency of the cable or bus may be lower so as to avoid the damage of the cable or bus.

Therefore, the motherboard module 22 is electrically connected to the extension circuit board 214 of the base module 21 through the connector 23 so as to receive the signals from extension module 212 or screen. In one embodiment of the present invention, the motherboard module 22 does not connect to the bus or cable. Thus, for removing the motherboard module, the only thing users need to do is to release the motherboard module 22 from the connector 23.

Further, a guide pin 27 may be used for assisting the motherboard module 22 in positioning, which making the motherboard module 22 connect to the base module 21 more easily. Also, the guide pin 27 may comprise a thread portion 271 and a protruding portion 272. The thread portion 271 is used for screwing the guide pin 27 onto the base module 21, and the protruding portion 272 is used for positioning the motherboard module 22.

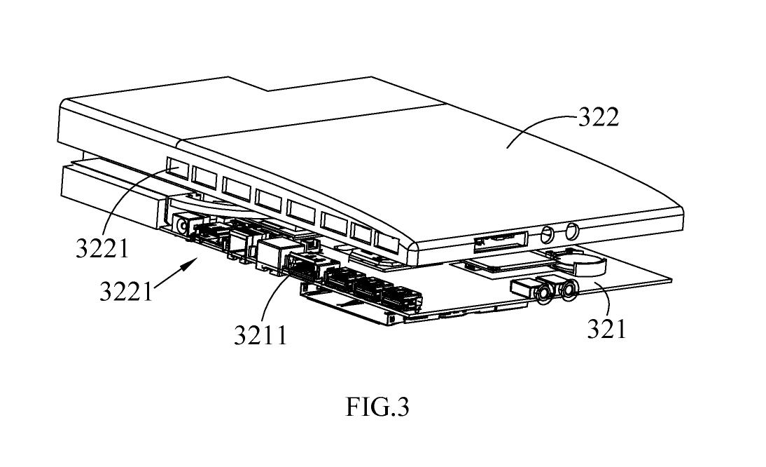

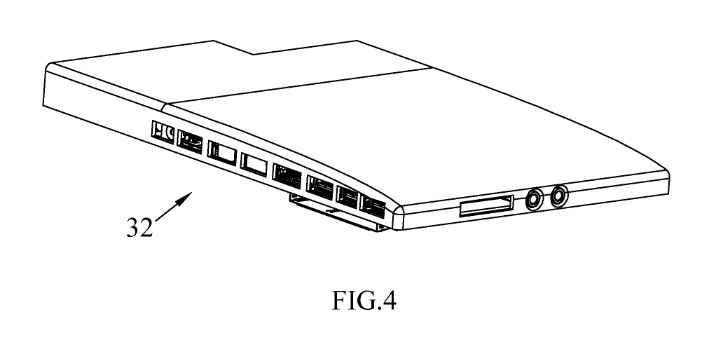

Please refer to FIG. 3 and FIG. 4, both illustrating the schematic view of the assembly of a motherboard module in accordance with one embodiment of the present invention. In FIG. 3 and FIG. 4, a motherboard module 32 comprises a motherboard 321 and a motherboard cover 322, and the motherboard cover 322 incorporates the appearance of the notebook computer. Further, the motherboard cover 322 comprises a plurality of holes 3221 to embed a plurality of input/output port 3211 of the motherboard 321 therein, such as the internet port, the audio input/output port, or USB port. As shown in FIG. 4, the exterior of the notebook computer may become more artistic.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention.

What is claimed is:

1. A notebook computer, comprising:
at least one connector;
a base module comprising a base and a base casing, the base disposed in the base casing;
a screen module pivotally connected to the base casing and electrically connected to the base; and
a motherboard module comprising a motherboard and a motherboard cover, the motherboard electrically connected to the base, and the motherboard cover integrated with the motherboard and disposed to cover one side of the motherboard;
wherein the base casing is seamlessly connecting to the motherboard cover when the motherboard electrically connects to the base.

2. The notebook computer as claimed in claim 1, wherein signals of the screen module are transmitted to the motherboard through the connector.

3. The notebook computer as claimed in claim 1, wherein the base comprises at least one extension module or at least one extension circuit board.

4. The notebook computer as claimed in claim 3, wherein the extension module is a hard disk or an optical disk.

5. The notebook computer as claimed in claim 3, further comprising an extension module signal bus electrically connected to the extension module and the base, signals transmitted via the extension module signal bus are sent to the motherboard through the connector.

6. The notebook computer as claimed in claim 1, wherein the motherboard cover comprises at least one hole.

7. The notebook computer as claimed in claim 1, wherein the base further comprises at least one guide pin to position the motherboard.

8. The notebook computer as claimed in claim 1, wherein the motherboard comprises at least one of a processor, a memory, and a chip set, the processor processes data and programs, the memory stores data and programs, and the chip set communicates with the processor and peripheral devices of the notebook computer.

9. The notebook computer as claimed in claim 1, wherein the motherboard further comprises a display chip to process the signals of the screen module.

10. The notebook computer as claimed in claim 1, wherein the motherboard further comprises an input/output interface port to connect with peripheral devices of the notebook computer.

11. The notebook computer as claimed in claim 10, wherein the input/output interface port is integrated with the motherboard cover.

12. The notebook computer as claimed in claim 8, further comprising a heat sink module removably connected to the motherboard.

13. A motherboard module assembled with a base module of a notebook computer comprising:
a motherboard comprising at least one of a processor, a memory, a chip set, and an input/output interface port, the processor processing data and programs, the memory storing data and programs, the chip set communicating with the processor and peripheral devices of the notebook computer, and the input/output interface port connecting with peripheral devices of the notebook computer; and
a motherboard cover integrated with the motherboard and disposed to cover one side of the motherboard, and the input/output interface integrated with the motherboard cover.

14. The motherboard module as claimed in claim 13, wherein the base casing of the base module is seamlessly connecting to the motherboard cover when the base casing is assembled with the base module.

15. The motherboard module as claimed in claim 13, further comprising a heat sink module removably connected to the motherboard.

16. The motherboard module as claimed in claim 13, wherein the motherboard further comprises a display chip.

17. The motherboard module as claimed in claim 13, wherein the motherboard comprises at least one hole.
